(19) United States
(12) Patent Application Publication
(10) Pub. No.: US 2025/0362505 A1
(43) Pub. Date: Nov. 27, 2025

(54) DISPLAY DEVICE AND AUGMENTED REALITY DEVICE INCLUDING THE SAME

(71) Applicant: SAMSUNG ELECTRONICS CO., LTD., Suwon-si (KR)

(72) Inventors: Sangwoo HA, Suwon-si (KR); Kyunglip PARK, Suwon-si (KR); Hyunsang PARK, Suwon-si (KR); Dongsoo LIM, Suwon-si (KR); Ingu HAN, Suwon-si (KR)

(73) Assignee: SAMSUNG ELECTRONICS CO., LTD., Suwon-si (KR)

(21) Appl. No.: 18/953,992

(22) Filed: Nov. 20, 2024

(30) Foreign Application Priority Data
May 22, 2024 (KR) 10-2024-0066738

(51) Int. Cl. G02B 27/01; G02B 27/09; G02B 27/12; G02B 27/28

(52) U.S. Cl. CPC G02B 27/0172; G02B 27/0916; G02B 27/0955; G02B 27/123; G02B 27/283; G02B 2027/0174

(57) ABSTRACT

A display device and an augmented reality device including the display device are provided. The display device includes a light source configured to provide first light, a light guide plate including a first surface and a second surface and configured to emit the first light provided from the light source to the second surface, and a transmissive spatial light modulator including a third surface facing the second surface of the light guide plate and a fourth surface and configured to modulate the first light incident on the third surface and emitted to the fourth surface to generate a holographic image. Each of the light guide plate and the transmissive spatial light modulator is configured to transmit external second light incident on the first surface of the light guide plate to a fourth surface of the transmissive spatial light modulator.

### CROSS-REFERENCE TO RELATED APPLICATION

This application is based on and claims priority under 35 U.S.C. § 119 to Korean Patent Application No. 10-2024-0066738, filed on May 22, 2024, in the Korean Intellectual Property Office, the disclosure of which is incorporated by reference herein in its entirety.

### BACKGROUND

### 1. Field

The disclosure relates to a display device and an augmented reality device including the same.

### 2. Description of the Related Art

Augmented reality (AR) devices, such as AR glasses, allow users to experience augmented reality. In a related art AR device, an image optical system of the AR device includes an image generating device that generates an image and an image combiner that sends the generated image to an eye of a user. AR devices according to the related art use an image combiner to combine an external image with a holographic image.

Recently, AR devices are developed to have a wide viewing angle and provide high-quality images. Also, AR devices are required to be lightweight and compact. However, AR devices using related art image combiners may have problems such as system complexity and increased weight and size.

### SUMMARY

Provided are a direct-view display device and an augmented reality device including the same.

Additional aspects will be set forth in part in the description which follows and, in part, will be apparent from the description, or may be learned by practice of the presented embodiments of the disclosure.

According to an aspect of the disclosure, there is provided a display device including: a light source configured to provide first light, which is coherent light; a light guide plate including a first surface and a second surface, the light guide plate configured to emit the first light incident on the first surface to the second surface; and a transmissive spatial light modulator including a third surface facing the second surface of the light guide plate and a fourth surface, the transmissive spatial light modulator configured to modulate the first light incident on the third surface and emitted to the fourth surface to generate a holographic image, wherein the light guide plate and the transmissive spatial light modulator are each configured to transmit external second light incident on the first surface of the light guide plate to the fourth surface of the transmissive spatial light modulator.

The light guide plate may include an in-coupler and an out-coupler provided on the first surface or the second surface, and wherein the light source is arranged to provide the first light to the in-coupler.

Each of the in-coupler and the out-coupler may include at least one of a diffractive optical element (DOE), a holographic optical element (HOE), or a meta surface.

The out-coupler may be configured to focus the first light emitted from the light source.

The display device may further include a planar lens provided on the fourth surface, the planar lens configured to focus light of the holographic image.

The planar lens may include a polarization-dependent planar lens.

The planar lens may include a wavelength-dependent planar lens.

The planar lens may include a fifth surface facing the fourth surface of the transmissive spatial light modulator and a sixth surface, and the display device may further include an optical element provided between the second surface of the light guide plate and the third surface of the transmissive spatial light modulator, between the fourth surface of the transmissive spatial light modulator and the fifth surface of the planar lens, or on the sixth surface of the planar lens, wherein the optical element includes at least one of a polarizer, a dichroic film, or a wave plate, the polarizer configured to transmit through light of a first polarization and absorb or reflect light of a second polarization different from the first polarization.

The display device may further include an optical element provided between the second surface of the light guide plate and the third surface of the transmissive spatial light modulator or on the fourth surface of the transmissive spatial light modulator, wherein the optical element may include at least one of a polarizer, a dichroic film, or a wave plate, the polarizer configured to transmit through light of a first polarization and absorb or reflect light of a second polarization different from the first polarization.

The display device may further include a polarization filter facing the first surface of the light guide plate.

According to another aspect of the disclosure, there is provided an augmented reality device including: a processor configured to generate holographic image data; a driver configured to output an image signal of the holographic image data; and a display device configured to provide a holographic image generated based on the image signal, wherein the display device includes: a light source configured to provide first light, which is coherent light; a light guide plate including a first surface and a second surface, the light guide plate configured to emit first light incident on the first surface to the second surface; and a transmissive spatial light modulator including a third surface facing the second surface of the light guide plate and a fourth surface, the transmissive spatial light modulator configured to modulate the first light incident on the third surface and emitted to the fourth surface to generate the holographic image, wherein the light guide plate and the transmissive spatial light modulator are each configured to transmit external second light incident on the first surface of the light guide plate to the fourth surface of the transmissive spatial light modulator.

### BRIEF DESCRIPTION OF DRAWINGS

The above and other aspects, features, and advantages of certain embodiments of the disclosure will be more apparent from the following description taken in conjunction with the accompanying drawings, in which:

FIGS. 1 to 3 are diagrams illustrating a schematic configuration of a display device according to an embodiment;

FIG. 4 is a diagram illustrating a schematic configuration of a driving portion of the display device of FIGS. 1 to 3;

FIG. 5 is a diagram illustrating a schematic configuration of a display device according to another embodiment;

FIG. 6 is a diagram illustrating an example of a pattern of an out-coupler of FIG. 5;

FIG. 7 is a diagram illustrating a schematic configuration of a display device according to another embodiment;

FIG. 8 is a diagram illustrating a schematic configuration of a display device according to another embodiment;

FIG. 9 is a diagram illustrating a schematic configuration of a display device according to another embodiment;

FIG. 10 is a diagram illustrating a schematic configuration of a display device according to another embodiment;

FIG. 11 is a diagram illustrating a schematic configuration of a display device according to another embodiment;

FIG. 12 is a diagram illustrating a schematic configuration of a display device according to another embodiment;

FIG. 13 is a diagram illustrating a schematic configuration of a display device according to another embodiment; and

FIG. 14 is a diagram schematically illustrating an augmented reality device according to an embodiment.

### DETAILED DESCRIPTION

Reference will now be made in detail to embodiments, examples of which are illustrated in the accompanying drawings, wherein like reference numerals refer to like elements throughout. In this regard, the example embodiments of the disclosure may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Below, with reference to the attached drawings, embodiments of the disclosure will be described in detail so that those skilled in the art can easily implement the disclosure. However, the disclosure may be implemented in many different forms and is not limited to the embodiments described herein. In order to clearly explain the disclosure in the drawings, parts that are not related to the description are omitted, and similar parts are given similar reference numerals throughout the specification.

The terms used in the embodiments of the disclosure are general terms that are currently widely used as much as possible while considering the function of the disclosure, but this may vary depending on the intention or precedent of a person working in the art, the emergence of new technology, etc. In addition, in certain cases, there are terms arbitrarily selected by the applicant, and in this case, the meaning will be described in detail in the description of the relevant embodiment. Therefore, the terms used in this specification should be defined based on the meaning of the term and the overall content of the disclosure, rather than simply the name of the term.

The singular forms include the plural forms unless the context clearly indicates otherwise. It should be understood that, when a part “comprises” or “includes” an element in the specification, unless otherwise defined, other elements are not excluded from the part and the part may further include other elements.

Hereinafter, the disclosure will be described in detail with reference to the attached drawings.

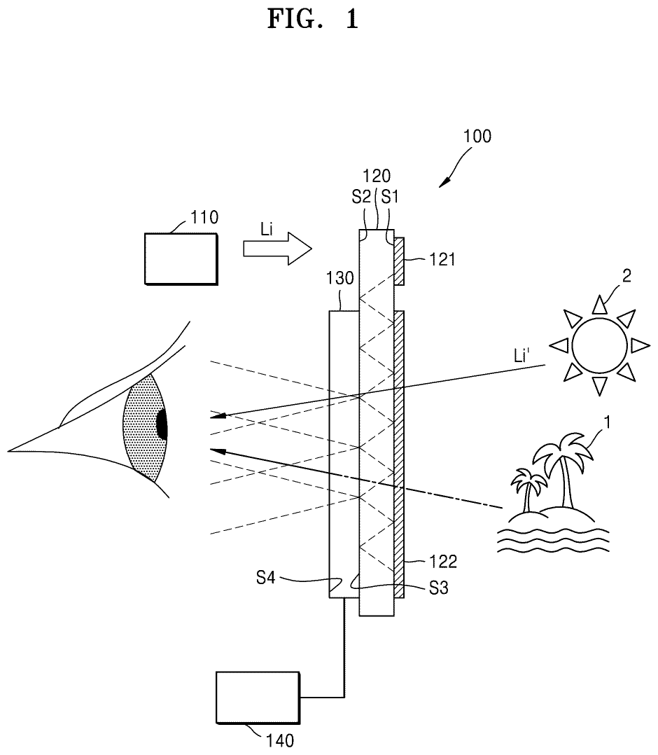

FIGS. 1 to 3 are diagrams schematically illustrating a display device 100 according to an embodiment.

Referring to FIG. 1, the display device 100 may include a light source 110, a light guide plate 120, and a transmissive spatial light modulator 130. According to some example embodiments, the display device 100 may further include a driving portion 140 that controls operations of the transmissive spatial light modulator 130. However, the disclosure is not limited to the components illustrated in FIG. 1, and as such, according to another embodiment, the display device 100 may include one or more other components.

The light source 110 may include a laser diode that emits a laser beam. However, the disclosure is not limited thereto, and as such, according to another embodiment, the light source 110 may be configured to emit light in a different manner. The laser beam emitted from the light source 110 may be coherent. For example, the light source 110 may provide coherent first light Li to the light guide plate 120, which will be described later. The first light Li may be light having a first wavelength or first polarization. The light source 110 may be arranged to provide the first light Li to an in-coupler 121 of the light guide plate 120, which will be described later.

The light guide plate 120 is a device (or an element) that propagates incident light through total internal reflection. In some examples, the light guide plate may be referred to as a wave guide. The light guide plate 120 may be a plate-shaped member including a first surface S1 and a second surface S2 facing the first surface S1. For example, the plate-shaped member may include the first surface S1 on a first side of the plate-shaped member and the second surface S2 on a second side of the plate-shaped member, which is opposite to the first side of the plate-shaped member. The light guide plate 120 may be configured to emit the first light Li provided from the light source 110, to the second surface S2.

The in-coupler 121 is an element that couples the first light Li emitted from the light source 110, to the light guide plate 120. For example, the in-coupler 121 inputs the first light Li into the light guide plate 120. The in-coupler 121 may be a diffractive element that diffracts the first light Li incident on the light guide plate 120 and inputs the first light Li into the light guide plate 120. For example, the diffractive element may be configured to diffract the first light Li incident on the light guide plate 120 into the light guide plate 120. The in-coupler 121 may include, but is not limited to, at least one of a diffractive optical element (DOE), a holographic optical element (HOE), or a meta surface. A meta surface may be formed by arranging multiple nanostructures on a two-dimensional surface. An out-coupler 122 is a device (or an element) that outputs the first light Li propagating within the light guide plate 120, out of the light guide plate 120. The out-coupler 122 may include, but is not limited to, at least one of, for example, a DOE, a HOE, or a meta surface.

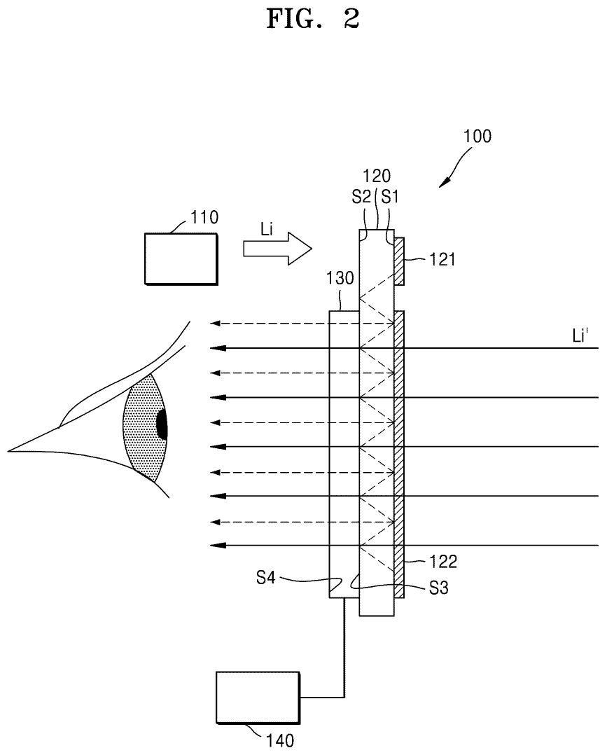

Referring to FIG. 2, the in-coupler 121 and the out-coupler 122 of the light guide plate 120 may be provided on the first surface S1 of the light guide plate 120. In this example case, the in-coupler 121 and the out-coupler 122 of the light guide plate 120 may include, but is not limited to, a reflective DOE, a reflective HOE, or a reflective meta surface. The in-coupler 121 may be configured to allow the first light Li incident on the first surface S1 of the light guide plate 120, to proceed to the second surface S2 at an angle greater than or equal to a critical angle and to propagate inside the light guide plate 120. The out-coupler 122 may be configured to cause a portion of the first light Li, which is totally reflected inside the light guide plate 120, to proceed toward the second surface S2 in a direction substantially perpendicular to the first surface S1, and be emitted outside the light guide plate 120. In FIG. 2, the in-coupler 121 and the out-coupler 122 provided on an outer surface of the first surface S1 of the light guide plate 120, are illustrated. However, the disclosure is not limited thereto. As such, according to another embodiment, the in-coupler 121 and the out-coupler 122 may also be provided on an inner surface of the first surface S1 of the light guide plate 120.

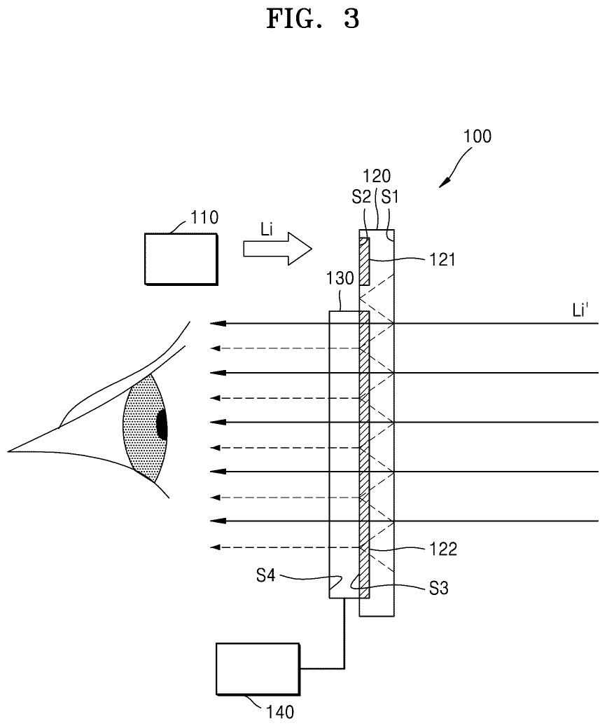

Referring to FIG. 3, the in-coupler 121 and the out-coupler 122 of the light guide plate 120 may be provided on the second surface S2 of the light guide plate 120. In this example case, the in-coupler 121 and the out-coupler 122 of the light guide plate 120 may include, but is not limited to, a transmissive DOE, a transmissive HOE, or a transmissive meta surface. The in-coupler 121 may be configured to allow the first light Li incident on the first surface S1 of the light guide plate 120, to proceed to the second surface S2 at an angle greater than or equal to a critical angle and propagate inside the light guide plate 120. The out-coupler 122 may be configured to cause a portion of the first light Li, which is totally internally reflected inside the light guide plate 120, to proceed outside of the second surface S2 at an angle that is substantially perpendicular to the second surface S2, and be emitted outside the light guide plate 120. In FIG. 3, the in-coupler 121 and the out-coupler 122 provided on an inner surface of the second surface S2 of light guide plate 120 are illustrated, but the in-coupler 121 and the out-coupler 122 may also be provided on an outer surface of the second surface S2 of the light guide plate 120.

In FIG. 2, the in-coupler 121 and the out-coupler 122 are provided on the first surface S1 of the light guide plate 120, and in FIG. 3, the in-coupler 121 and the out-coupler 122 are provided on the second surface S2 of the light guide plate 120. However, the disclosure is not limited thereto, and as such, according to another embodiment, any one of the in-coupler 121 and the out-coupler 122, may be provided on the first surface S1 of the light guide plate 120, and the other one of the in-coupler 121 and the out-couplers 122 may be provided on the second surface S2 of the light guide plate 120.

The transmissive spatial light modulator 130 is a device (or an element) that generates a holographic image (or image) by modulating incident coherent light. The transmissive spatial light modulator 130 may include a third surface S3 facing the second surface S2 of the light guide plate 120 and a fourth surface S4 facing the third surface S3. For example, the transmissive spatial light modulator 130 may include the third surface S3 on a first side of the transmissive spatial light modulator 130 and the fourth surface S4 on a second side of the transmissive spatial light modulator 130, which is opposite to the first side of the transmissive spatial light modulator 130. For example, the third surface S3 may contact the second surface S2 of the light guide plate 120. The transmissive spatial light modulator 130 may be configured to generate a holographic image by modulating the first light Li incident on the third surface S3 and emitted to the fourth surface S4. The driving portion 140 may be electrically connected to the transmissive spatial light modulator 130. The transmissive spatial light modulator 130 may receive an image signal from the driving portion 140 and modulate at least one of the amplitude and phase of the first light Li incident from the light source 110 according to the image signal. Accordingly, the transmissive spatial light modulator 130 may cause the first light Li emitted from the light source 110, to include a holographic image.

The transmissive spatial light modulator 130 may include, for example, an optical electrical device capable of changing the refractive index via an electrical signal. The transmissive spatial light modulator 130 may include, for example, a layer of optical electrical material, such as a liquid crystal layer. In an example case in which a voltage is applied to the optical electrical material layer included in the transmissive spatial light modulator 130, a refractive index of the optical electrical material layer may change, and the amplitude or phase of light incident on the transmissive spatial light modulator 130 may be modulated accordingly. For example, the transmissive spatial light modulator 130 may include, but is not limited to, a digital micro mirror (DMD), a high-temperature polycrystalline silicon liquid crystal display (HTPS LCD), a low temperature polycrystalline silicon liquid crystal display (LTPS LCD), or a lift-off after forming a pixel circuit on a liquid crystal on silicon (LCoS)-silicon on insulator (SOI).

The transmissive spatial light modulator 130 and the light guide plate 120 may include a material that is transparent in the visible light band. The light guide plate 120 may include a transparent material in the wavelength band of light, in which the in-coupler 121 and the out-coupler 122 operate. For example, the light guide plate 120 may include, but is not limited to, glass or polymer material with a transmittance of 90% or more in the visible light band. According to an embodiment, since the transmissive spatial light modulator 130 and the light guide plate 120 include a transparent material in the visible light band, light may be transmitted in a thickness direction of the transmissive spatial light modulator 130 and the light guide plate 120. For example, the light guide plate 120 and the transmissive spatial light modulator 130 may be configured to transmit second light Li′ from the outside 2 incident on the first surface S1 of the light guide plate 120, through the fourth surface S4 of the transmissive spatial light modulator 130 towards an eye of a user. Accordingly, the user may view a real scene outside along with a holographic image 1 through the transmissive spatial light modulator 130 and the light guide plate 120.

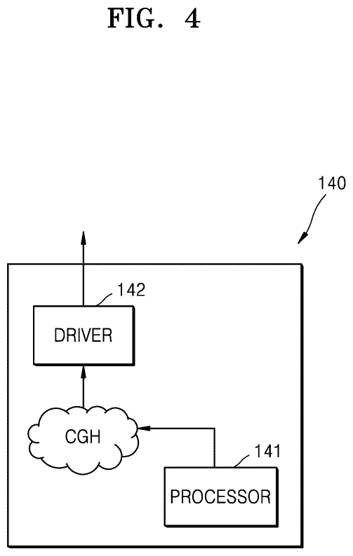

FIG. 4 is a diagram illustrating a schematic configuration of the driving portion 140 of the display device 100 of FIGS. 1 to 3.

Referring to FIG. 4, the driving portion 140 of the display device 100 may include a processor 141 and a driver 142. The processor 141 may include, but is not limited to, at least one hardware component. For example, the hardware component may include, but is not limited to, a central processing unit, a microprocessor, a graphics processing unit, application specific integrated circuits (ASICs), digital signal processors (DSPs), digital signal processing devices (DSPDs), programmable logic devices (PLDs), and field programmable gate arrays (FPGAs). The processor 141 may generate, for example, data of a holographic image (or an image) such as a computer-generated hologram (CGH) and transmit the same to the driver 142. The driver 142 may receive holographic image data from the processor 141 and output an image signal to the transmissive spatial light modulator 130.

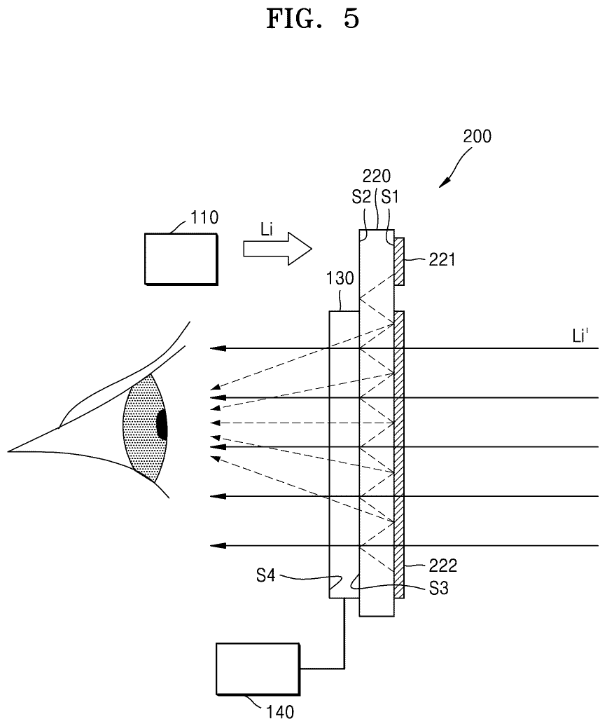

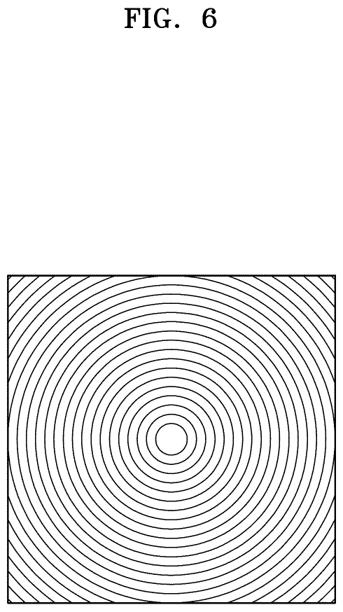

FIG. 5 is a diagram illustrating a schematic configuration of a display device according to another embodiment, and FIG. 6 is a diagram illustrating a pattern of an out-coupler of FIG. 5 as an example. In FIGS. 5 and 6, components using the same reference numerals as those in FIGS. 1 to 3 have substantially the same configuration and operational effects as those described above, and therefore detailed description thereof will be omitted here.

Referring to FIG. 5, a display device 200 may include a light guide plate 220 configured to focus first light Li emitted to the second surface S2. The light guide plate 220 may include an in-coupler 221 and an out-coupler 222. The out-coupler 222 may have a pattern that focuses the first light Li. For example, the out-coupler 222 of the light guide plate 220 may have a plurality of concentric circular patterns as illustrated in FIG. 6. The first light Li may be diffracted through a pattern of the out-coupler 222, emitted to the second surface S2 of the light guide plate 220, and focused in a certain area. In this manner, the angle of view or field of view (FoV) of the holographic image generated by the transmissive spatial light modulator 130 or the eye-box of the user may be adjusted. For example, the FoV or eyebox may be expanded through a light focusing function of the out-coupler 222.

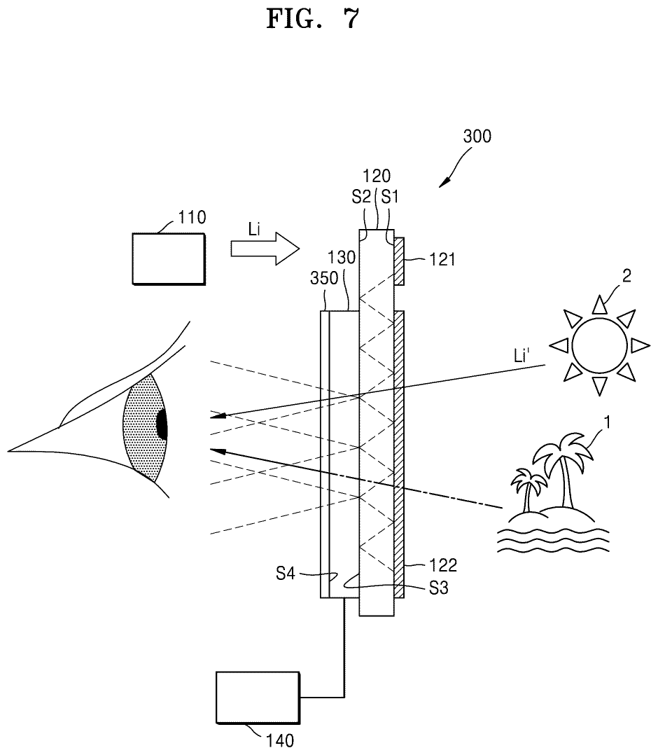

FIG. 7 is a diagram illustrating a schematic configuration of a display device according to another embodiment. In FIG. 7, components using the same reference numerals as those in FIGS. 1 to 3 have substantially the same configuration and operational effects as those described above, and therefore detailed description thereof will be omitted here.

Referring to FIG. 7, a display device 300 may further include an optical element 350 provided to face the fourth surface S4 of the transmissive spatial light modulator 130. For example, the optical element 350 may be provided on the fourth surface S4 of the transmissive spatial light modulator 130. For example, a side surface of the optical element 350 may contact the fourth surface S4 of the transmissive spatial light modulator 130. The optical element 350 may be configured to remove noise from a holographic image by adjusting or filtering polarization of incident light. The optical element 350 may include a polarizer. For example, the polarizer may be a linear polarizer or a circular polarizer. In an example case in which the optical element 350 is a polarizer, the polarizer may transmit light of first polarization and absorb or reflect light of second polarization different from the first polarization. According to an embodiment, the optical element 350 may further include a dichroic film. For example, the optical element 350 may include a dichroic film instead of a polarizer. According to an embodiment, in conjunction with or instead of a polarizer and/or dichroic film, the optical element 350 may include a wave plate. The wave plate may include a half-wave plate or a quarter-wave plate. The optical element 350 may remove or reduce direct current (DC) noise, high-order diffraction images, and complex conjugate images that may occur in the transmissive spatial light modulator 130 by blocking polarization, phase, or wavelength components that are different from those of a reproduced holographic image.

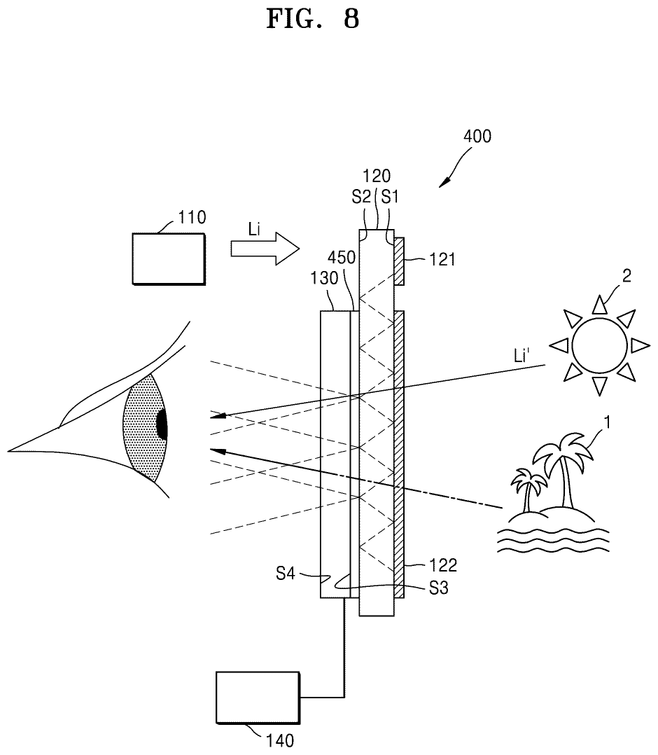

FIG. 8 is a diagram illustrating a schematic configuration of a display device according to another embodiment. In FIG. 8, components using the same reference numerals as those in FIGS. 1 to 3 have substantially the same configuration and operational effects as those described above, and therefore detailed description thereof will be omitted here.

Referring to FIG. 8, a display device 400 may further include an optical element 450 provided to face the third surface S3 of the transmissive spatial light modulator 130. For example, the optical element 450 may contact the third surface S3 of the transmissive spatial light modulator 130. The optical element 450 may also contact the second surface S2 of the light guide plate 120. The optical element 450 may be the same component as the optical element 350 described with reference to FIG. 7, but the location thereof may be different.

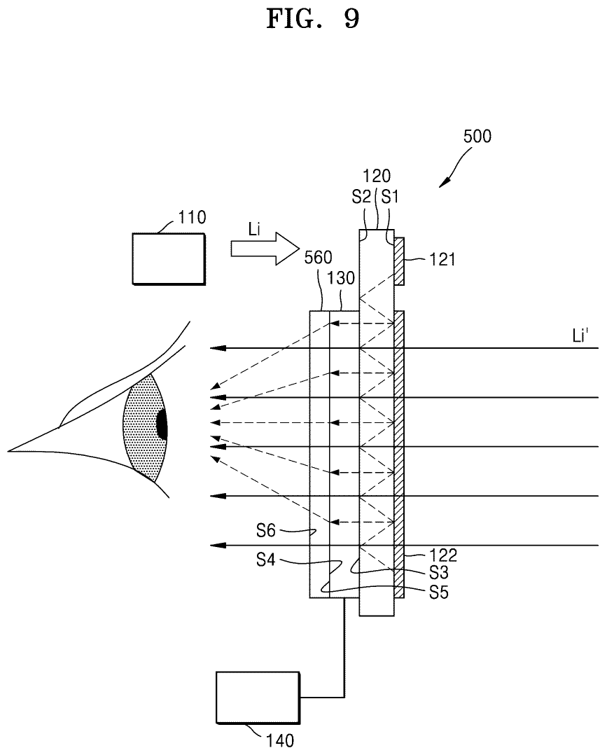

FIG. 9 is a diagram illustrating a schematic configuration of a display device according to another embodiment. In FIG. 9, components using the same reference numerals as those in FIGS. 1 to 3 have substantially the same configuration and operational effects as those described above, and therefore detailed description thereof will be omitted here.

Referring to FIG. 9, a display device 500 may further include a planar lens 560 provided to face the fourth surface S4 of the transmissive spatial light modulator 130. The planar lens 560 may include, for example, a geometry phase (GP) lens, a HOE, or a meta-lens. The planar lens 560 may include a fifth surface S5 opposite the fourth surface S4 of the transmissive spatial light modulator 130 and a sixth surface S6 opposite the fifth surface S5. For example, the planar lens 560 may include the fifth surface S5 on a first side of the planar lens 560 and the sixth surface S6 on a second side of the planar lens 560, which is opposite to the fifth side of the planar lens 560. The planar lens 560 may be configured so that the first light Li incident on the fifth surface S5 is emitted to the sixth surface S6 and is focused in an area. The planar lens 560 may be configured so that the external second light Li′ incident on the fifth surface S5 directly passes through the sixth surface S6. Through the planar lens 560, the FoV of the holographic image or an eyebox of the user eyebox may be adjusted without distortion of an external image.

The planar lens 560 may be a wavelength-dependent lens or a polarization-dependent lens. In an example case in which the planar lens 560 is a wavelength-dependent lens, the planar lens 560 may be configured to focus only the first light Li of the first wavelength and directly transmit light having a different wavelength from the first wavelength. In other words, the planar lens 560 may act as a lens only for light of the first wavelength and may act as a flat plate with no refractive power for light with other wavelengths. In another example case in which the planar lens 560 is a polarization-dependent lens, the planar lens 560 may be configured to focus only the first light Li of the first polarization and directly transmit light having a polarization component different from the first polarization. In other words, the planar lens 560 may act as a lens only for light of the first polarization and may act as a flat plate having no refractive power for light with other polarizations. Accordingly, the first light Li of the first wavelength or first polarization may be focused by the planar lens 560, and most of the second light Li′ from the outside may not be focused by the planar lens 560 but be transmitted through the lens 560 as is.

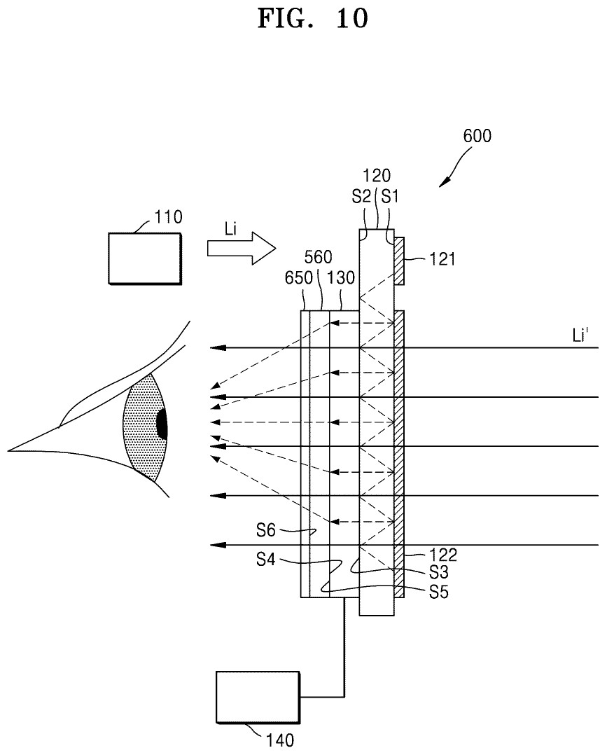

FIG. 10 is a diagram illustrating a schematic configuration of a display device according to another embodiment. Components using the same reference numerals as those in FIGS. 1 to 3 and 9 have substantially the same configuration and operational effects as those described above, and therefore detailed description thereof will be omitted here.

Referring to FIG. 10, a display device 600 may further include an optical element 650 provided to face a sixth surface S6 of the planar lens 560. The optical element 650 may include, at least one of, for example, a polarizer, a dichroic film, or a wave plate. The polarizer may be a linear polarizer of a circular polarizer. The wave plate may be a half wave plate or a quarter wave plate. In an example case in which the optical element 650 is a polarizer, the optical element 650 may transmit through light of the first polarization and absorb or reflect light of the second polarization different from the first polarization.

The optical element 650 may be configured to remove noise from a holographic image by adjusting or filtering the polarization of incident light. The optical element 650 may include a polarizer. The polarizer may be a linear polarizer of a circular polarizer. In an example case in which the optical element 650 is a polarizer, the polarizer may transmit through light of the first polarization and absorb or reflect light of the second polarization different from the first polarization. In addition to or instead of a polarizer, optical element 650 may include a dichroic film. According to an embodiment, in conjunction with or instead of a polarizer and/or dichroic film, the optical element 650 may include a wave plate. The wave plate may be a half wave plate or a quarter wave plate. The optical element 650 may remove or reduce DC noise, high-order diffraction images, and complex conjugate images that may occur in the transmissive spatial light modulator 130 by blocking polarization, phase, or wavelength components that are different from those of a reproduced holographic image.

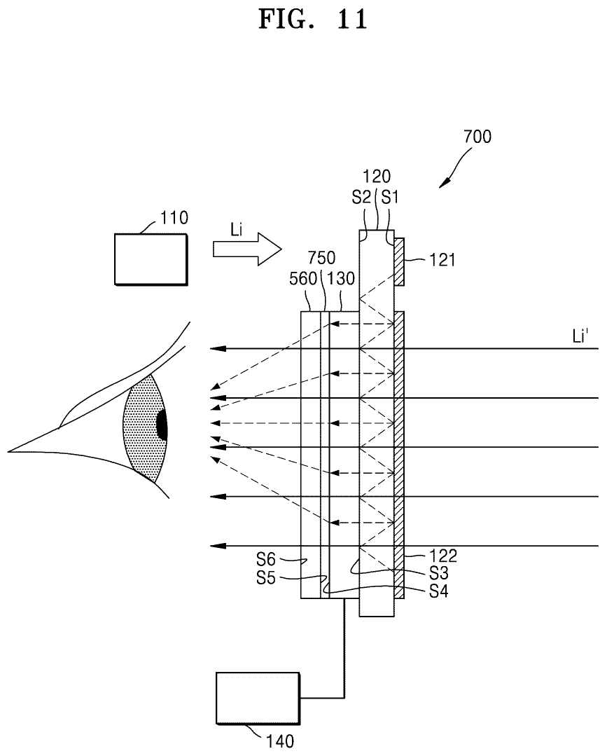

FIG. 11 is a diagram illustrating a schematic configuration of a display device according to another embodiment. In FIG. 11, components using the same reference numerals as those in FIGS. 1 to 3 and 9 have substantially the same configuration and operational effects as those described above, and therefore detailed description thereof will be omitted here.

Referring to FIG. 11, a display device 700 may further include an optical element 750 provided between the fifth surface S5 of the planar lens 560 and the fourth surface S4 of the transmissive spatial light modulator 130. The optical element 750 may be the same component as the optical element 650 described with reference to FIG. 10, but the location thereof may be different.

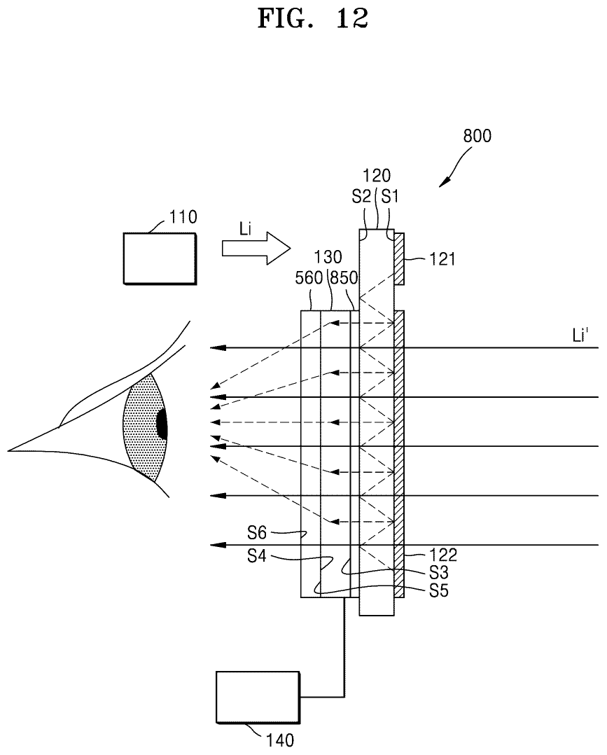

FIG. 12 is a diagram illustrating a schematic configuration of a display device according to another embodiment. In FIG. 12, components using the same reference numerals as those in FIGS. 1 to 3 and 9 have substantially the same configuration and operational effects as those described above, and therefore detailed description thereof will be omitted here.

Referring to FIG. 12, a display device 800 may further include an optical element 850 provided between the third surface S3 of the transmissive spatial light modulator 130 and the second surface S2 of the light guide plate 120. The optical element 850 may be the same component as the optical element 650 described with reference to FIG. 10, but the location thereof may be different.

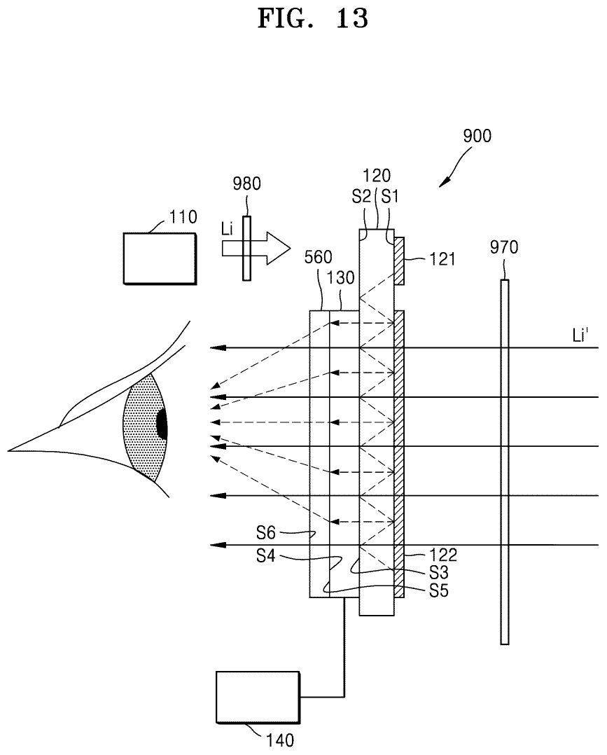

FIG. 13 is a diagram illustrating a schematic configuration of a display device according to another embodiment. In FIG. 13, components using the same reference numerals as those in FIGS. 1 to 3 and 9 have substantially the same configuration and operational effects as those described above, and therefore detailed description thereof will be omitted here.

Referring to FIG. 13, a display device 900 may further include an optical element 970 provided to face the first surface S1 of the light guide plate 120. The optical element 970 may be provided on an optical path through which the second light Li′ from the outside enters the light guide plate 120. In other words, the optical element 970 may be provided on the front surface of the light guide plate 120 in the path of the second light Li′. The optical element 970 may be spaced apart from the first surface S1 of the light guide plate 120, but may also be provided to directly contact the first surface S1 of the light guide plate 120. The optical element 970 may be configured to reduce distortion of the second light Li′ caused by the planar lens 560. The optical element 970 may include, for example, a polarization filter. The optical element 970 may include, for example, a Bragg mirror.

The display device 900 may further include an optical element 980 provided on an optical path through which the first light Li enters the light guide plate 120. The optical element 980 may include a polarizer (e.g., a linear polarizer or a circular polarizer).

In an example case in which the planar lens 560 is a polarization-dependent lens, the optical element 980 provided on the optical path of the first light Li causes the first light Li to have the first polarization, and the optical element 970 provided on the optical path allows the second light Li′ to have the second polarization, and the planar lens 560 may be configured to focus only the first light Li having the first polarization.

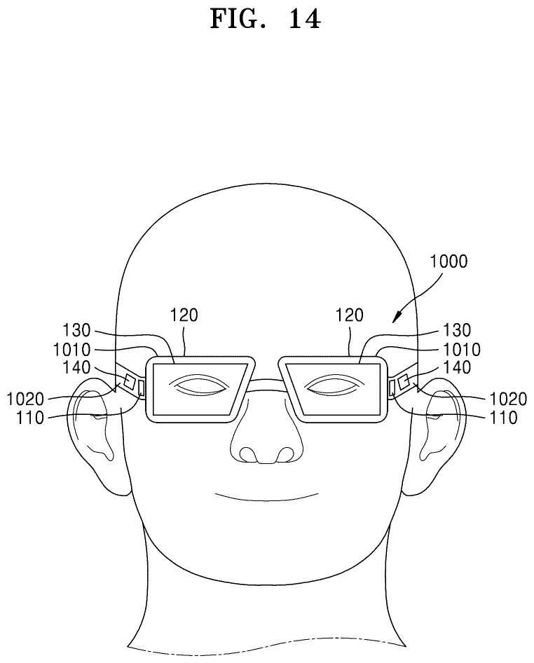

FIG. 14 is a diagram schematically illustrating components of an augmented reality device according to an embodiment.

Referring to FIG. 14, an augmented reality device 1000 may be configured as a wearable device that a user can wear on the body. For example, the augmented reality device 1000 may include augmented reality glasses (AR glasses) configured to be secured to a face or a head of the user. In this case, the augmented reality device 1000 may include a body 1010 and leg portions 1020. Additionally, the augmented reality device 1000 may include a display device. The display device may include, for example, a light source 110, a light guide plate 120, a transmissive spatial light modulator 130, and a driving portion 140. For convenience, only the light source 110, the light guide plate 120, the transmissive spatial light modulator 130, and the driving portion 140 are illustrated in FIG. 12, but the augmented reality device 1000 is similar to the display devices 100, 200, 300, 400, 500, 600, 700, 800, and 900 described with reference to FIGS. 1 to 13.

The body 1010 may be provided at a position corresponding to the front of the eyeballs of a viewer. The light guide plate 120 and the transmissive spatial light modulator 130 may be mounted on the front side of the body 1010 facing the eyeballs of the viewer. The leg portions 1020 may be contact members for wearing the augmented reality device 1000 on the face of the viewer. For example, the leg portions 1020 may be configured to secure the augmented reality device 1000 on the face of the user. The leg portions 1020 may be provided at positions corresponding to the left and right sides of the viewer, respectively.

FIG. 14 illustrates the light source 110, the light guide plate 120, the transmissive spatial light modulator 130, and the driving portion 140 which are provided on the left and right sides, respectively, but the disclosure is not limited thereto. In an embodiment, at least one of the light source 110, the light guide plate 120, the transmissive spatial light modulator 130, and the driving portion 140 may be provided on either the left or right side. For example, the light guide plate 120 and the transmissive spatial light modulator 130 may be provided across the entire left and right sides, and the driving portion 140 may be located in a middle portion and commonly provided for both the left and right sides, or may be provided to correspond to each of the left and right sides.

External light incident from the outside may pass through the light guide plate 120 and the transmissive spatial light modulator 130, and the external light may be provided to an eye of the user along with a holographic image generated from the augmented reality device 1000.

A distance between the augmented reality device 1000 and the user may be same or similar to a distance between the user and typical glasses worn by the user. For example, the distance between the augmented reality device 1000 and the user may be about 15 mm to about 25 nm. In an example case in which the augmented reality device 1000 includes a planar lens, the distance between the augmented reality device 1000 and the user may increase to approximately 35 nm.

In the disclosure, a display device applied to augmented reality glasses is mainly described, but it will be obvious to those skilled in the art that it the disclosure may be applied to near-eye displays and heads-up display (HUD) devices that can express virtual reality.

In this disclosure, an ‘augmented reality device’ refers to a device capable of expressing augmented reality, which includes not only glasses-shaped augmented reality glasses worn by a user on the face, but also the head, such as a head mounted display (HMD), an augmented reality helmet, and a head up display (HUD) worn on the body.

As described above, external light passes through a transmissive spatial light modulator and a light guide plate and is provided to the user along with a holographic image, thereby reducing the size and thickness of the augmented reality device 1000 compared to an augmented reality device using an image combiner. Additionally, since the augmented reality device 1000 further includes a planar lens, the FoV of the holographic image may be increased without increasing the size of the augmented reality device 1000, and an eyebox of the user may be expanded.

As the display device and the augmented reality device including the same according to the disclosure include a transmissive spatial light modulator and a light guide plate configured to transmit external light, a user may view an external image and a holographic image simultaneously.

In addition, according to the display device and the augmented reality device including the same according to the disclosure, by further including a planar lens, the FoV of a holographic image and the eyebox of a user may be adjusted.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A display device comprising:
a light source configured to provide first light, which is coherent light;
a light guide plate comprising a first surface and a second surface, the light guide plate configured to emit the first light incident on the first surface to the second surface; and
a transmissive spatial light modulator comprising a third surface facing the second surface of the light guide plate and a fourth surface, the transmissive spatial light modulator configured to modulate the first light incident on the third surface and emitted to the fourth surface to generate a holographic image,
wherein the light guide plate and the transmissive spatial light modulator are each configured to transmit external second light incident on the first surface of the light guide plate to the fourth surface of the transmissive spatial light modulator.

2. The display device of claim 1, wherein the light guide plate comprises an in-coupler and an out-coupler provided on the first surface or the second surface, and
wherein the light source is arranged to provide the first light to the in-coupler.

3. The display device of claim 2, wherein each of the in-coupler and the out-coupler comprise at least one of a diffractive optical element (DOE), a holographic optical element (HOE), or a meta surface.

4. The display device of claim 2, wherein the out-coupler is configured to focus the first light emitted from the light source.

5. The display device of claim 1, further comprising a planar lens provided on the fourth surface, the planar lens configured to focus light of the holographic image.

6. The display device of claim 5, wherein the planar lens comprises a polarization-dependent planar lens.

7. The display device of claim 5, wherein the planar lens comprises a wavelength-dependent planar lens.

8. The display device of claim 5, wherein
the planar lens comprises a fifth surface facing the fourth surface of the transmissive spatial light modulator and a sixth surface, and
the display device further comprises an optical element provided between the second surface of the light guide plate and the third surface of the transmissive spatial light modulator, between the fourth surface of the transmissive spatial light modulator and the fifth surface of the planar lens, or on the sixth surface of the planar lens,
wherein the optical element comprises at least one of a polarizer, a dichroic film, or a wave plate, the polarizer configured to transmit through light of a first polarization and absorb or reflect light of a second polarization different from the first polarization.

9. The display device of claim 1, further comprising an optical element provided between the second surface of the light guide plate and the third surface of the transmissive spatial light modulator or on the fourth surface of the transmissive spatial light modulator,
wherein the optical element comprises at least one of a polarizer, a dichroic film, or a wave plate, the polarizer configured to transmit through light of a first polarization and absorb or reflect light of a second polarization different from the first polarization.

10. The display device of claim 1, further comprising a polarization filter facing the first surface of the light guide plate.

11. An augmented reality device comprising:
a processor configured to generate holographic image data;
a driver configured to output an image signal of the holographic image data; and
a display device configured to provide a holographic image generated based on the image signal,
wherein the display device comprises:
a light source configured to provide first light, which is coherent light;
a light guide plate comprising a first surface and a second surface, the light guide plate configured to emit first light incident on the first surface to the second surface; and
a transmissive spatial light modulator comprising a third surface facing the second surface of the light guide plate and a fourth surface, the transmissive spatial light modulator configured to modulate the first light incident on the third surface and emitted to the fourth surface to generate the holographic image,
wherein the light guide plate and the transmissive spatial light modulator are each configured to transmit external second light incident on the first surface of the light guide plate to the fourth surface of the transmissive spatial light modulator.

12. The augmented reality device of claim 11, wherein the light guide plate comprises an in-coupler and an out-coupler provided on the first surface or the second surface, and
wherein the light source is arranged to provide the first light to the in-coupler.

13. The augmented reality device of claim 12, wherein each of the in-coupler and the out-coupler comprise at least one of a diffractive optical element (DOE), a holographic optical element (HOE), or a meta surface.

14. The augmented reality device of claim 12, wherein the out-coupler is configured to focus the first light from the light source.

15. The augmented reality device of claim 11, further comprising a planar lens provided on the fourth surface, the planar lens configured to focus light of the holographic image.

16. The augmented reality device of claim 15, wherein the planar lens comprises a polarization-dependent planar lens.

17. The augmented reality device of claim 15, wherein the planar lens comprises a wavelength-dependent planar lens.

18. The augmented reality device of claim 15, wherein
the planar lens comprises a fifth surface facing the fourth surface of the transmissive spatial light modulator and a sixth surface, and
the augmented reality device further comprises an optical element provided between the second surface of the light guide plate and the third surface of the transmissive spatial light modulator, between the fourth surface of the transmissive spatial light modulator and the fifth surface of the planar lens, or on the sixth surface of the planar lens,
wherein the optical element comprises at least one of a polarizer, a dichroic film, or a wave plate, the polarizer configured to transmit through light of a first polarization and absorb or reflect light of a second polarization different from the first polarization.

19. The augmented reality device of claim 11, further comprising an optical element provided between the second surface of the light guide plate and the third surface of the transmissive spatial light modulator or on the fourth surface of the transmissive spatial light modulator,
wherein the optical element comprises at least one of a polarizer, a dichroic film, or a wave plate, the polarizer configured to transmit through light of a first polarization and absorb or reflect light of a second polarization different from the first polarization.

20. The augmented reality device of claim 11, further comprising a polarization filter facing the first surface of the light guide plate.
